(19) United States
(12) Patent Application Publication
(10) Pub. No.: US 2026/0077319 A1
(43) Pub. Date: Mar. 19, 2026

(54) NANOBUBBLE GENERATION IN FLUID FLOW

(71) Applicant: Moleaer, Inc., Hawthorne, CA (US)

(72) Inventors: Thuy Thi Bui, Torrance, CA (US); Ryan Phillip Gogue-Radcliffe, San Pedro, CA (US); Sohail Akhter, Carson, CA (US)

(21) Appl. No.: 19/332,360

(22) Filed: Sep. 18, 2025

Related U.S. Application Data
(60) Provisional application No. 63/696,108, filed on Sep. 18, 2024.

(51) Int. Cl. B01F 23/2375; B01F 23/232

(52) U.S. Cl. CPC B01F 23/2375; B01F 23/2323

(57) ABSTRACT

A nanobubble generating device includes a tubular structure and open channels. The tubular structure has an inner surface. The tubular structure defines an inlet port and an outlet port on opposing ends of the tubular structure for enabling fluid flow through the device. The open channels are disposed on the inner surface of the tubular structure. The open channels extend along at least a portion of a length of the tubular structure between the inlet port and the outlet port. A fluid is flowed across the open channels. Nanobubbles are generated in the fluid in response to flowing the fluid across the open channels.

### CLAIM OF PRIORITY

This application claims priority to U.S. Provisional Application No. 63/696,108, filed Sep. 18, 2024, the contents of which are incorporated here by reference in their entirety.

### TECHNICAL FIELD

This disclosure relates to generation of bubbles in fluids, and in particular, generation of nanobubbles in fluids.

### BACKGROUND

Nanobubbles are stable in liquid carriers for extended periods of time, allowing them to be transported without coalescing or dissolving in the liquid carrier. In addition, nanobubbles also promote high gas transfer in the liquid carrier due to their high internal pressure. These properties make nanobubbles useful in a variety of fields, including water treatment, plant growth, aquaculture, and sterilization.

### SUMMARY

This disclosure describes technologies relating to generation of nanobubbles in fluids. Certain aspects of the subject matter described can be implemented as a nanobubble generating device. The device includes a tubular structure and open channels. The tubular structure has an inner surface and an outer surface. The tubular structure defines an inlet port and an outlet port on opposing ends of the tubular structure for enabling fluid flow through the device. The open channels are disposed on the inner surface of the tubular structure. The open channels extend along at least a portion of a length of the tubular structure between the inlet port and the outlet port.

This, and other aspects, can include one or more of the following features. A number of open channels can be at least two. A depth of the open channels can be less than about 10 millimeters (mm). The depth of the open channels can be less than about 5 mm. The depth of the open channels can be in a range from about 0.5 mm to about 2 mm. The depth of the open channels can be about 1 mm. A width of each open channel can be less than about 10 mm. The width of each open channel can be less than about 5 mm. The width of each open channel can be in a range from about 0.5 mm to about 2 mm. Each of the open channels can be bounded by walls that are vertical, slanted, or curved with respect to a baseline of the respective open channel. A width of the walls of each of the open channels can be less than about 10 mm. The width of the walls of each of the open channels can be less than about 5 mm. The width of the walls of each of the open channels can be in a range from about 0.5 mm to about 5 mm. The walls bounding the open channels can have geometrical cross-sectional shapes selected from square, rectangle, hemisphere, ellipse, triangle, trapezoid, rhombus, or any combinations or composites of these. The open channels can be integrally formed with the inner surface of the tubular structure. The open channels can be part of an insert or attachment that is coupled to the tubular structure. The tubular structure can be partitioned into at least two sub-tubular structures. The device can include a second tubular structure. The first tubular structure and the second tubular structure can be integrally formed as a composite structure. The first tubular structure and the second tubular structure can be connected to a common manifold. The device can include open channels disposed on an inner surface of the second tubular structure. The tubular structure can be configured to receive a fluid by the inlet port and discharge the fluid by the outlet port for flowing the fluid across the open channels. The device can be configured to, in response to the fluid flowing into the inlet port, across the open channels, and out of the outlet port, impose a pressure loss on the fluid of less than about 2 pounds per square inch (psi) differential. The fluid can include dissolved gas at a dissolved gas concentration of at least 1 milligram per liter (mg/L). The open channels can be configured to, in response to the fluid flowing across the open channels, convert at least a portion of the dissolved gas into nanobubbles to generate nanobubbles in the fluid. The open channels can be configured to generate nanobubbles in the fluid independent of introduction of a gas distinct from the dissolved gas present in the fluid. The device can be configured to generate nanobubbles in the fluid at a concentration of at least 1 million nanobubbles per milliliter of fluid. The device can be configured to generate nanobubbles having an average diameter of less than 1 micrometer. A cross-sectional area of the tubular structure through which the fluid flows can decrease at a location intermediate of the inlet port and the outlet port. The open channels can be a first plurality of open channels. The device can include a second plurality of open channels disposed on the outer surface of the tubular structure. The second plurality of open channels can extend along at least a portion of the length of the tubular structure.

Certain aspects of the subject matter described can be implemented as a method. The method includes flowing a fluid through the tubular structure of the nanobubble generating device.

Certain aspects of the subject matter described can be implemented as a method. The method includes flowing a fluid across open channels disposed on an inner surface of a tubular structure. The fluid is a liquid that includes dissolved gas. The method includes generating nanobubbles in the fluid in response to flowing the fluid across the open channels.

This, and other aspects, can include one or more of the following features. Generating nanobubbles in the fluid can include converting at least a portion of the dissolved gas into nanobubbles. The fluid that is flowed across the open channels can have a Reynolds number greater than about 2,000. The fluid that is flowed across the open channels can have a Reynolds number greater than about 8,000. The fluid that is flowed across the open channels can have a Reynolds number in a range from about 8,000 to about 30,000. Flowing the fluid across the open channels can cause a pressure loss on the fluid of less than 2 pounds per square inch (psi) differential. The fluid can have a dissolved gas concentration of at least 1 milligram per liter (mg/L). The nanobubbles can be generated in the fluid independent of introduction of a gas distinct from the dissolved gas present in the fluid. The nanobubbles can be generated in the fluid such that the fluid has a nanobubble concentration of at least 1 million nanobubbles per milliliter of fluid. The nanobubbles generated in the fluid can have an average diameter of less than 1 micrometer. The method can include flowing the fluid across open channels disposed on an outer surface of the tubular structure. The method can include generating nanobubbles in the fluid in response to flowing the fluid across the open channels disposed on the outer surface of the tubular structure.

Certain aspects of the subject matter described can be implemented as a nanobubble generating device. The device includes a tubular structure having an inner surface and an outer surface. The tubular structure defines an inlet port and an outlet port on opposing ends of the tubular structure for enabling fluid flow through the device. The device includes a first plurality of open channels disposed on the inner surface of the tubular structure. The first plurality of open channels extends along at least a portion of a length of the tubular structure between the inlet port and the outlet port. The device includes a second plurality of open channels disposed on the outer surface of the tubular structure. The second plurality of open channels extends along at least a portion of the length of the tubular structure between the inlet port and the outlet port.

Certain aspects of the subject matter described can be implemented as a nanobubble generating assembly. The assembly includes a device, a connecting member, and a housing. The device includes a tubular structure, a first plurality of open channels, and a second plurality of open channels. The tubular structure has an inner surface and an outer surface. The tubular structure defines an inlet port and an outlet port on opposing ends of the tubular structure for enabling fluid flow through the device. The first plurality of open channels is disposed on the inner surface of the tubular structure. The first plurality of open channels extends along at least a portion of a length of the tubular structure between the inlet port and the outlet port. The second plurality of open channels is disposed on the outer surface of the tubular structure. The second plurality of open channels extends along at least a portion of the length of the tubular structure between the inlet port and the outlet port. The connecting member includes an inlet and an outlet. The inlet of the connecting member is configured to couple to a first pipe for receiving a fluid from the first pipe. The outlet of the connecting member is configured to couple to a second pipe for discharging the fluid to the second pipe. The connecting member is configured to couple to the inlet port of the device for establishing fluid communication between the inlet of the connecting member and the inlet port of the device. The housing is configured to couple to the connecting member. The housing defines a void space for surrounding the device. The assembly defines an annulus as a portion of the void space between the housing and the outer surface of the tubular structure. The housing is shaped to direct flow of the fluid out of the outlet port of the device to the annulus. The annulus is in fluid communication with the outlet of the connecting member when the housing is coupled to the connecting member for discharging the fluid from the assembly.

Certain aspects of the subject matter described can be implemented as a method. The method includes flowing a fluid into an inlet port of a tubular structure and across open channels disposed on an inner surface of the tubular structure. The fluid is a liquid comprising dissolved gas. The method includes generating nanobubbles in the fluid in response to flowing the fluid across the open channels disposed on the inner surface of the tubular structure. The method includes flowing the fluid out of an outlet port of the tubular structure. The method includes directing flow of the fluid from the outlet port across open channels disposed on an outer surface of the tubular structure. The method includes generating nanobubbles in the fluid in response to flowing the fluid across the open channels disposed on the outer surface of the tubular structure.

The subject matter described in this disclosure can be implemented in particular implementations, so as to realize one or more of the following advantages. The devices described can be free of moving parts, and therefore may not require motorized equipment to operate. The devices described can be compact in size (for example, smaller than 2 inches in diameter). The devices and methods described employ open channels to generate such nanobubbles. The devices described include a tubular structure within which the open channels are situated and through which the flowing fluid can flow in a turbulent regime. The fluid flow through the tubular structure and across the open channels in the turbulent regime, and the open channels induce generation of nanobubbles. The devices and methods described are free of significant obstructions in the flow path of the flowing fluid, thereby imposing minimal pressure drop on the flowing fluid. The devices described can include multiple tubular structures that are integrally formed together to create a larger conduit structure and/or multiple tubular structures connected by a manifold to handle larger fluid flow. The devices and methods described can be operated independent of an external gas source for introducing gas to generate nanobubbles. In some cases, additional gas can be introduced to generate a larger concentration of nanobubbles in the flowing fluid. The devices and methods described employ open channels that capitalize on turbulence of a flowing fluid to induce generation of nanobubbles. The open channels can allow for generation of nanobubbles in the flowing fluid while minimizing contact area to mitigate the negative effects of friction on pressure drop of the flowing fluid. It was found during testing that devices including open channels generated high concentrations of nanobubbles in a flowing fluid, for example, in nanobubble concentrations greater than 1 million nanobubbles per milliliter of the fluid. Further, such devices with open channels were compared against control devices with closed channels (e.g., channels with a covered top) with the same cross-sectional area as the analogous open channels (with other dimensions remaining the same), and it was found that the control devices with closed channels were unable to generate an appreciable amount nanobubbles in the flowing fluid, let alone generate nanobubbles at high concentrations (such as nanobubble concentrations greater than 1 million nanobubbles per milliliter of the fluid).

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a flow chart of a method for generating nanobubbles in fluid flow.

FIG. 2 is a diagram of an example device for generating nanobubbles in fluid flow.

FIG. 3 is a diagram of an example device for generating nanobubbles in fluid flow.

FIG. 4A is a cross-sectional view of an example system for generating nanobubbles in fluid flow.

FIG. 4B is a side view of an example system for generating nanobubbles in fluid flow.

FIG. 5A is a side view of an example device for generating nanobubbles in fluid flow.

FIG. 5B is a perspective view of the device of FIG. 5A.

FIG. 6A is a perspective view of an example assembly for generating nanobubbles in fluid flow which includes the device of FIG. 5A.

FIG. 6B is a side view of the assembly of FIG. 6A.

FIG. 6C is a cross-sectional view of the assembly of FIG. 6A.

FIG. 7 is a diagram of an example system for generating nanobubbles in fluid flow.

### DETAILED DESCRIPTION

This disclosure describes nanobubble generation in a flowing fluid. In some cases, dissolved gas already present in the flowing fluid is converted into nanobubbles to generate nanobubbles in the flowing fluid. In some cases, additional gas (such as oxygen, nitrogen, air, or a gas including any combinations of these) can be introduced to generate nanobubbles which can disperse into the flowing fluid to aerate the fluid. The nanobubbles generated by the devices and methods described have diameters less than one micrometer (μm). In some implementations, the nanobubbles generated by the devices and methods described have diameters less than or equal to about 500 nanometers (nm).

Some non-limiting examples of applications of the subject matter described are provided here. The devices and methods described can be implemented in a flowline flowing a fluid in which aeration is desired, such as a flowline flowing a fluid including water (e.g., treated wastewater, oilfield produced water, reclaimed water, or potable water).

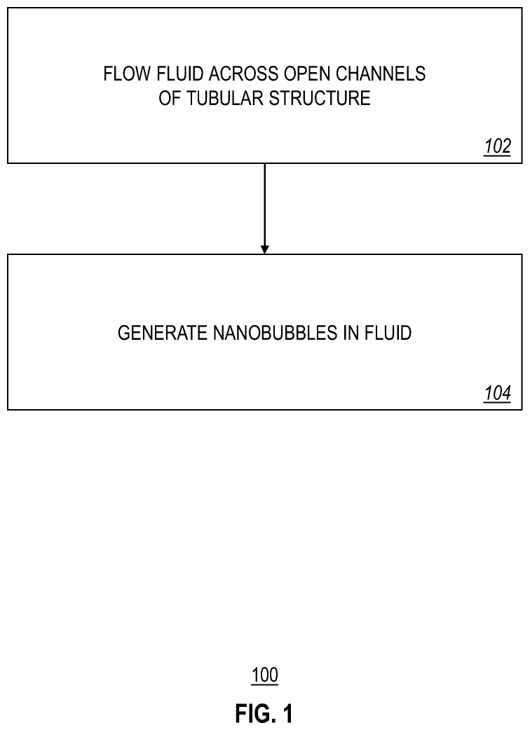

FIG. 1 is a flow chart of a method 100 for generating nanobubbles in fluid flow. At block 102, a fluid (such as a fluid containing water) is flowed across open channels disposed on an inner surface of a tubular structure. In response to flowing the fluid across the open channels at block 102, nanobubbles are generated in the fluid at block 104.

In some implementations, nanobubbles are generated in the fluid at block 104 such that the fluid has a nanobubble concentration of at least 1 million nanobubbles per milliliter of the fluid. In some implementations, the nanobubbles generated in the fluid at block 104 have an average diameter of less than about 1 μm or less than about 500 nm.

The fluid flowed across the open channels at block 102 can be a liquid that includes dissolved gas. For example, the fluid flowed across the open channels at block 102 has a dissolved gas concentration of at least 1 mg/L. In some implementations, generating nanobubbles in the fluid at block 104 includes converting at least a portion of the dissolved gas into nanobubbles. In some implementations, nanobubbles are generated in the fluid at block 104 independent of introduction of a gas that is distinct from the dissolved gas present in the fluid. In some implementations, the method 100 includes introducing a gas into the fluid prior to flowing the fluid across the open channels at block 102. For example, gas can be dissolved in the fluid such that the fluid has a dissolved gas concentration of at least 1 mg/L prior to flowing across the open channels at block 102.

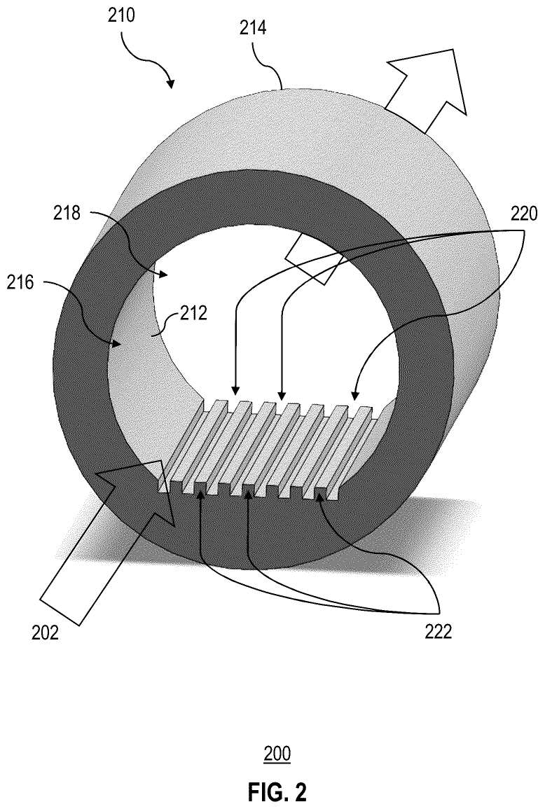

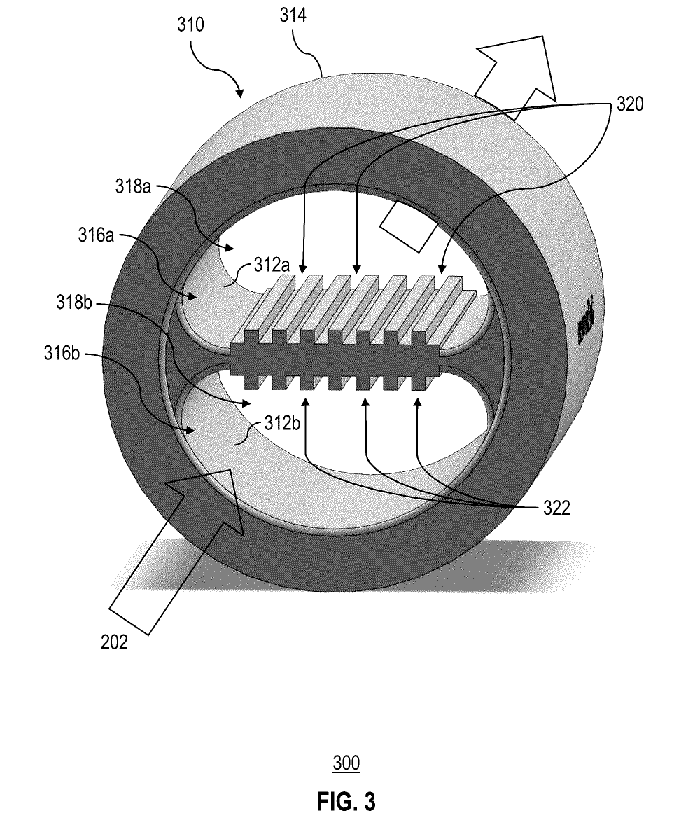

In some implementations, the method 100 includes introducing a gas into the fluid prior to flowing the fluid across the open channels at block 102, for example, in a device (such as a device 200 or a device 300, which are shown in FIGS. 2 and 3, respectively, and described in greater detail later). The fluid that is flowed across the open channels at block 102 can shear the gas from a surface of the device (for example, a surface of the open channels) to generate the nanobubbles at block 104.

In some implementations, the fluid that is flowed across the open channels at block 102 has a Reynolds number that is greater than about 2,000 or greater than about 8,000. For example, the fluid that is flowed across the open channels at block 102 has a Reynolds number that is in a range of from about 8,000 to about 30,000. In some implementations, flowing the fluid across the open channels at block 102 causes a pressure loss on the fluid of less than about 2 psi differential or less than about 1 psi differential.

FIG. 2 depicts an example nanobubble generating device 200. The device 200 can, for example, be used to implement the method 100. The device 200 includes a tubular structure 210 that has an inner surface 212 and an outer surface 214. Open channels 220 are positioned along at least a portion of the inner surface 212 of the tubular structure 210. The tubular structure 210 defines an inlet port 216 and an outlet port 218. The inlet port 216 and the outlet port 218 are on opposing ends of the tubular structure 210 for enabling flow of fluid (such as a fluid 202) through the device 200. The inlet port 216 and the outlet port 218 can, for example, be connected to a flowline (not shown) flowing the fluid 202. The tubular structure 210 is configured to receive the fluid 202 by the inlet port 216 and to discharge the fluid 202 by the outlet port 218. The open channels 220 extend along at least a portion of a length of the tubular structure 210 between the inlet port 216 and the outlet port 218. Fluid flowing through the device 200 flows into the inlet port 216, across the open channels 220, and out of the outlet port 218. The device 200 is configured to, in response to the fluid 202 flowing into the inlet port 216, across the open channels 220, and out of the outlet port 218, impose a pressure loss on the fluid 202 of less than about 2 pounds per square inch (psi) differential or less than about 1 psi differential.

Through the presence of the open channels 220, the device 200 is configured to generate nanobubbles in the fluid 202 at a concentration of at least 1 million nanobubbles per milliliter of the fluid 202. For example, while the fluid 202 entering the inlet port 216 might be substantially free of nanobubbles, the fluid 202 exiting the outlet port 218 has a nanobubble concentration of at least 1 million nanobubbles per milliliter of the fluid 202. The nanobubbles generated by the device 200 and included in the fluid 202 exiting the outlet port 218 can have an average diameter of less than one μm or less than 500 nm.

In some implementations, the fluid 202 entering the device 200 includes dissolved gas (e.g., oxygen, nitrogen, air, or a gas including any combinations of these) at a dissolved gas concentration of at least 1 milligram per liter (mg/L). The open channels 220 of the device 200 are configured to convert at least a portion of the dissolved gas into nanobubbles to generate nanobubbles in the fluid 202, independent of introduction of a gas distinct from the dissolved gas already present in the fluid 202.

In the implementation illustrated in FIG. 2, the tubular structure 210 is substantially tubular with a substantially constant cross-sectional area. In some implementations, a cross-sectional area of the tubular structure 210 through which the fluid 202 flows decreases at a location intermediate of the inlet port 216 and the outlet port 218. For example, the tubular structure 210 can have the structure of a Venturi device. The decreased cross-sectional area (constriction) can accelerate the rate of fluid flow through this portion of the tubular structure 210. In some implementations, the open channels 220 are disposed on the inner surface 212 at a portion of the tubular structure 210 with a decreased cross-sectional (constricted) area in comparison to the cross-sectional area of at least one of the inlet port 216 or the outlet port 218.

Each of the open channels 220 is defined as open space between neighboring walls 222. The walls 222 can be, for example, integrally formed with the tubular structure 210 (e.g., as a unitary body) or part of an insert or attachment that is coupled to the tubular structure 210. The walls 222 can be made of a flexible or rigid material. The illustrated open channels 220 are straight and extend parallel to a longitudinal axis of the tubular structure 210. In some embodiments, the open channels have a curvature, e.g., have a spiral or undulating shape extending along the length of the tubular structure, a rifled profile along the length of an otherwise straight or spiral channel, or another suitable configuration with a curvature. The configuration of the open channel can impact the nature of fluid flow through the tubular structure 210.

The height of the neighboring walls 222 corresponds to the depth of the respective open channel 220. In some implementations, the depth of each of the open channels 220 is less than about 10 millimeters (mm), less than about 5 mm, less than about 2 mm, or less than about 1 mm. For example, the depth of each of the open channels 220 is about 1 mm or in a range from about 0.5 mm to about 2 mm. In some cases, decreasing the depth of the open channels 220 can improve generation of nanobubbles in the fluid 202. The horizontal distance between neighboring walls 222 corresponds to the width of the respective open channel 220. In some implementations, the width of each of the open channels 220 is less than about 10 mm, less than about 5 mm, less than about 2 mm, or less than about 1 mm. For example, the width of each of the open channels 220 is about 1 mm or in a range from about 0.5 mm to about 2 mm. In some cases, decreasing the width of the open channels 220 can improve generation of nanobubbles in the fluid 202.

In the implementation illustrated in FIG. 2, the walls 222 have a rectangular shape, and the walls 222 are vertical with respect to a baseline (e.g., a reference horizontal, such as a floor) of the open channels. In some implementations, one or more of the walls 222 that bound the respective open channel 220 is slanted, or curved with respect to a reference vertical of the respective open channel 220. For instance, the walls 222 can have geometrical cross-sectional shapes such as hemisphere, ellipse, triangle, trapezoid, rhombus, or any combinations or composites of these. In the illustrated implementation, each of the walls 222 has the same shape. In some implementations, each of the walls 222 has the same shape but is of different size/scale. In some implementations, one or more of the walls 222 have a different shape from the remaining walls 222. In some implementations, one or more of the walls 222 have a different size/dimension from the remaining walls 222. In some cases where neighboring walls 222 are not uniform in size and/or shape, the width of the respective open channel 220 can be defined as the horizontal distance between the tops of the neighboring walls 222. In some cases where neighboring walls 222 are not uniform in size and/or shape, the depth of the respective open channel 220 can be defined as the height of the shorter wall 222.

In some implementations, the number of walls 222 is greater than the number of open channels 220 by one. For example, a device can include three walls, corresponding to two open channels. In some implementations, the device 200 includes at least two open channels 220 (for example, three, four, five, six, seven, eight, nine, ten, or more than ten). Apart from the walls 222 that bound the open channels 220, the inner bore of the tubular structure 210 can be free of any additional protrusions in order to minimize contact area between the fluid 202 and the inner surface 212 of the device 200, thereby mitigating frictional/pressure losses as the fluid 202 flows through the device 200.

The device 200 is connected to a source of liquid that provides the fluid 202 (for example, water). In some implementations, the source of liquid is a vessel or body of water connected to a pump via a suction line. In some implementations, the pump is a variable speed pump. In some implementations, the pump is connected to the device 200 via a discharge line with a control valve. In some implementations, the discharge line is in fluid communication with the tubular structure 210. For example, the liquid carrier flows from the pump, through the control valve, through the discharge line, and to the inlet port 216. The percent opening of the control valve can be adjusted to control the pressure and flow rate of the liquid carrier flowed to the device 200.

In some implementations, the device 200 is connected to a source of gas. In some implementations, the source of gas is connected to the tubular structure 210, the open channels 220, or both. In some implementations, the gas is flowed into the tubular structure 210, the open channels 220, or both, and the gas can diffuse from the device 200 into the fluid 202 as the fluid 202 flows through the device 200. As the fluid 202 flows through the device 200, the gas that has diffused from the device 200 into the fluid 202 can be converted into nanobubbles. For example, as the gas diffuses from the device 200 and into the fluid 202, the flow of the fluid 202 can shear the gas to generate nanobubbles in the flowing fluid 202. In some implementations, gas is injected into the fluid 202 prior to the fluid 202 flowing into the device 200 (e.g., upstream of the inlet port 216). Introduction of gas can be facilitate generation of nanobubbles in the fluid 202, especially in cases where the fluid 202 has a dissolved gas concentration that is less than one mg/L. In some cases, introduction of additional gas may not be necessary, for example, in cases where the fluid 202 already has a dissolved gas concentration that is equal to or greater than one mg/L. In some cases, introduction of additional gas may be desired, for example, in cases where additional generation of nanobubbles in the fluid 202 is desired to produce a fluid having an even greater concentration of nanobubbles.

FIG. 3 depicts an example device 300 constructed in accordance with the concepts herein. The device 300 includes a tubular structure 310 that has a first inner surface 312a, a second inner surface 312b, and an outer surface 314. Open channels 320 are positioned along at least a portion of the first inner surface 312a and at least a portion of the second inner surface 312b of the tubular structure 310. The tubular structure 310 defines a first inlet port 316a, a second inlet port 316a, a first outlet port 318a, and a second outlet port 318b. The first inlet port 316a and the first outlet port 318a are on opposing ends of the tubular structure 310 for enabling flow of a first portion of fluid (such as the fluid 202) through the device 300. The second inlet port 316b and the second outlet port 318b are on opposing ends of the tubular structure 310 for enabling flow of a remaining portion of the fluid 202 through the device 300. The inlet ports 316a, 316b and the outlet ports 318a, 318b can, for example, be connected to a flowline (not shown) flowing the fluid 02. The tubular structure 310 is configured to receive the fluid 202 by the inlet ports 316a, 316b. The tubular structure 310 is configured to discharge the fluid 202 by the outlet ports 318a, 318b. The open channels 320 extend along at least a portion of a length of the tubular structure 310 between the inlet ports 316a, 316b and the outlet ports 318a, 318b. A first portion of the fluid 202 flowing through the device 300 flows into the first inlet port 316a, across a portion of the open channels 320, and out of the first outlet port 318a. A remaining portion of the fluid 202 flowing through the device 300 flows into the second inlet port 316b, across a remaining portion of the open channels 320, and out of the second outlet port 318b. The device 300 is configured to, in response to the fluid 202 flowing into the inlet ports 316a, 316b, across the open channels 320, and out of the outlet ports 318a, 318b, impose a pressure loss on the fluid 202 of less than about 2 psi differential or less than about 1 psi differential.

Through the presence of the open channels 320, the device 300 is configured to generate nanobubbles in the fluid 202 at a concentration of at least 1 million nanobubbles per milliliter of the fluid 202. For example, while the fluid 202 entering the inlet port 316 might be substantially free of nanobubbles, the fluid 202 exiting the outlet ports 318a, 318b has a nanobubble concentration of at least 1 million nanobubbles per milliliter of the fluid 202. The nanobubbles generated by the device 300 and included in the fluid 202 exiting the outlet ports 318a, 318b can have an average diameter of less than one μm or less than 500 nm.

In some implementations, the fluid 202 entering the device 300 includes dissolved gas at a dissolved gas concentration of at least 1 mg/L. The open channels 320 of the device 300 are configured to convert at least a portion of the dissolved gas into nanobubbles to generate nanobubbles in the fluid 202, independent of introduction of a gas distinct from the dissolved gas already present in the fluid 202.

In the implementation illustrated in FIG. 3, the tubular structure 310 is substantially tubular with a substantially constant cross-sectional area. In some implementations, a cross-sectional area of the tubular structure 310 through which the fluid 202 flows decreases at a location intermediate of the inlet ports 316a, 316b and the outlet ports 318a, 318b. For example, the tubular structure 310 can have the structure of a Venturi device. The decreased cross-sectional area (constriction) can accelerate the rate of fluid flow through this portion of the tubular structure 310. In some implementations, the open channels 320 are positioned along the inner surfaces 312a, 312b at a portion of the tubular structure 310 with a decreased cross-sectional (constricted) area in comparison to the cross-sectional area of at least one of the inlet ports 316a, 316b or the outlet ports 318a, 318b.

Each of the open channels 320 is defined as open space between neighboring walls 322. The walls 322 can be, for example, integrally formed with the tubular structure 310 or part of an insert or attachment that is coupled to the tubular structure 310. The walls 322 can be made of a flexible or rigid material. The height of the neighboring walls 322 corresponds to the depth of the respective open channel 320. In some implementations, the depth of each of the open channels 320 is less than about 10 mm, less than about 5 mm, less than about 2 mm, or less than about 1 mm. For example, the depth of each of the open channels 320 is about 0.5 mm or in a range from about 1 mm to about 2 mm. The horizontal distance between neighboring walls 322 corresponds to the width of the respective open channel 320. In some implementations, the width of each of the open channels 320 is less than about 10 mm, less than about 5 mm, less than about 2 mm, or less than about 1 mm. For example, the width of each of the open channels 320 is about 1 mm or in a range from about 0.5 mm to about 2 mm.

In some implementations, as shown in FIG. 3, the walls 322 bounding the open channels 320 extend into the first inner bore defined by the first inner surface 312a and into the second inner bore defined by the second inner surface 312b in opposite directions. In some implementations, the walls 322 bounding the open channels 320 can extend into the first inner bore defined by the first inner surface 312a and into the second inner bore defined by the second inner surface 312b in the same direction or in different directions, such as toward each other (e.g., from opposing portions of the tubular structure 310) or at different angles.

In the implementation illustrated in FIG. 3, the walls 322 have a rectangular shape, and the walls 322 are vertical with respect to a baseline (e.g., a reference horizontal, such as a floor) of the open channels. In some implementations, one or more of the walls 322 that bound the respective open channel 320 is slanted, or curved with respect to a baseline (e.g., a reference horizontal, such as a floor) of the respective open channel 220. For instance, the walls 322 can have geometrical cross-sectional shapes such as hemisphere, ellipse, triangle, trapezoid, rhombus, or any combinations or composites of these. In the illustrated implementation, each of the walls 322 has the same shape. In some implementations, each of the walls 322 has the same shape but is of different size/scale. In some implementations, one or more of the walls 322 have a different shape from the remaining walls 322. In some implementations, one or more of the walls 322 have a different size/dimension from the remaining walls 322. In some cases where neighboring walls 322 are not uniform in size and/or shape, the width of the respective open channel 320 can be defined as the horizontal distance between the tops of the neighboring walls 322. In some cases where neighboring walls 322 are not uniform in size and/or shape, the depth of the respective open channel 320 can be defined as the height of the shorter wall 322. In some implementations, as shown in FIG. 3, the walls 322 are positioned along a dividing wall that divides the inner bore of the tubular structure 310 into a first inner bore (defined by the first inner surface 312a) and a second inner bore (defined by the second inner surface 312b) across which the total flow of the fluid 202 is divided. In some implementations, as shown in FIG. 3, the device 322 is free of dividing walls that intersect with one another. In some implementations, it can be desirable to increase the cross-sectional flow areas of the first and second inner bores defined by the first and second inner surfaces 312a, 312b, respectively for most of (e.g., at least half of) the tubular structure 310 (e.g., along its longitudinal length) in order to minimize frictional/pressure losses of the flow of the fluid 202.

In some implementations, the number of walls 322 is greater than the number of open channels 322 by one. For example, a device can include three walls, corresponding to two open channels. In some implementations, the device 300 includes at least two open channels 320 (for example, three, four, five, six, seven, eight, nine, ten, or more than ten). Apart from the walls 322 that bound the open channels 320, the inner bores of the tubular structure 310 can be free of any additional protrusions in order to minimize contact area between the fluid 202 and the inner surfaces 312a, 312b of the device 300, thereby mitigating frictional/pressure losses as the fluid 202 flows through the device 300.

In some implementations, the device 300 is connected to a source of liquid that provides the fluid 202 (for example, water). In some implementations, the source of liquid is a vessel or body of water connected to a pump via a suction line. In some implementations, the pump is a variable speed pump. In some implementations, the pump is connected to the device 300 via a discharge line with a control valve. In some implementations, the discharge line is in fluid communication with the tubular structure 310. For example, the liquid carrier flows from the pump, through the control valve, through the discharge line, and to the inlet ports 316a, 316b. The percent opening of the control valve can be adjusted to control the pressure and flow rate of the liquid carrier flowed to the device 300.

In some implementations, the device 300 is connected to a source of gas. In some implementations, the source of gas is connected to the tubular structure 310, the open channels 320, or both. In some implementations, the gas is flowed into the tubular structure 310, the open channels 320, or both, and the gas can diffuse from the device 300 into the fluid 202 as the fluid 202 flows through the device 300. As the fluid 202 flows through the device 300, the gas that has diffused from the device 300 into the fluid 202 can be converted into nanobubbles. For example, as the gas diffuses from the device 300 and into the fluid 202, the flow of the fluid 202 can shear the gas to generate nanobubbles in the flowing fluid 202. In some implementations, gas is injected into the fluid 202 prior to the fluid 202 flowing into the device 300 (e.g., upstream of the inlet ports 316a, 316b). Introduction of gas can be facilitate generation of nanobubbles in the fluid 202, especially in cases where the fluid 202 has a dissolved gas concentration that is less than one mg/L. In some cases, introduction of additional gas may not be necessary, for example, in cases where the fluid 202 already has a dissolved gas concentration that is equal to or greater than one mg/L. In some cases, introduction of additional gas may be desired, for example, in cases where additional generation of nanobubbles in the fluid 202 is desired to produce a fluid having an even greater concentration of nanobubbles.

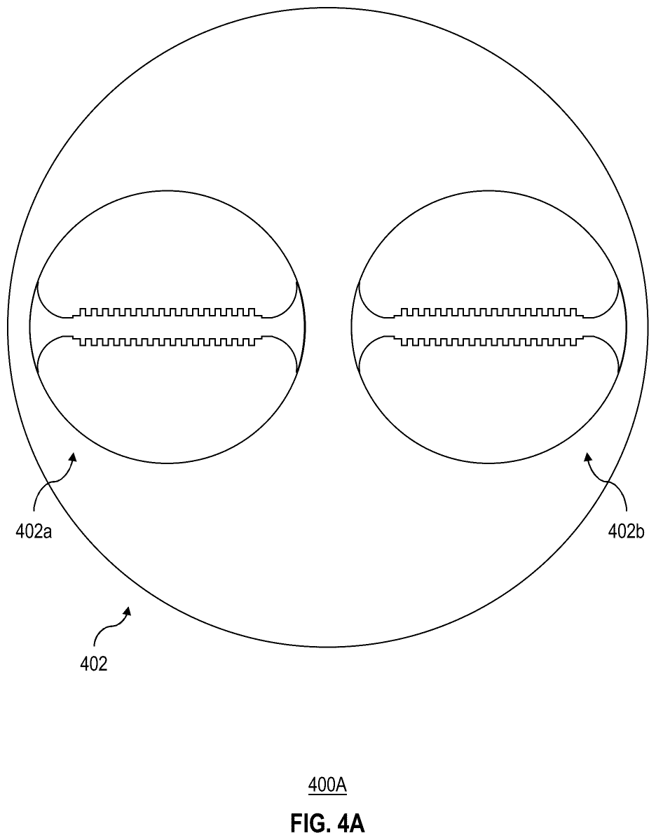

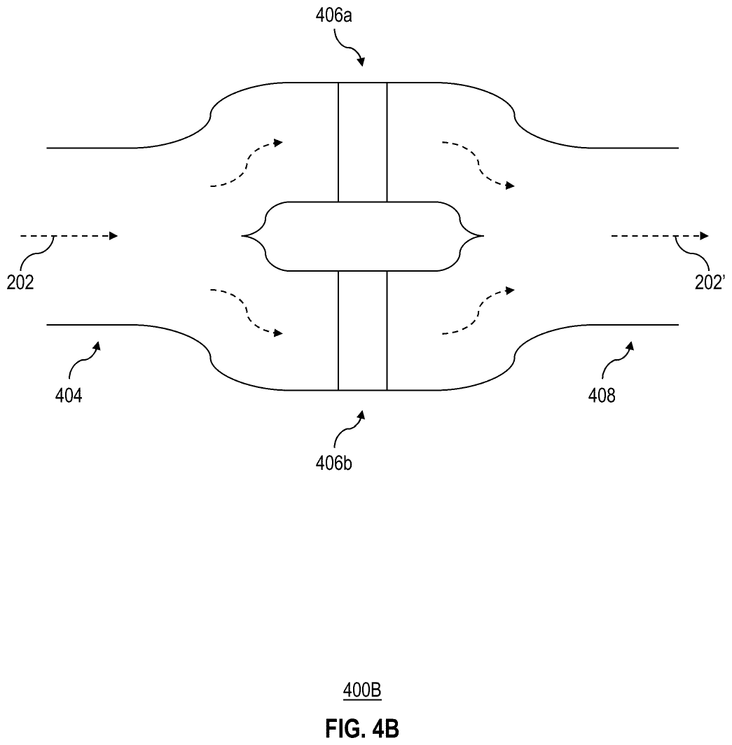

FIG. 4A is a cross-sectional view of an example system 400A for generating nanobubbles in flowing fluid. The system 400A includes a tubular structure 402 that is partitioned into sub-tubular structures 402a, 402b. Although shown in FIG. 4A as including two sub-tubular structures (402a, 402b), the tubular structure 402 can, in other implementations, be partitioned into additional sub-tubular structures (such as three, four, or more than four). By including more than one sub-tubular structure, the system 400A can, for example, accommodate larger flow of the fluid 202 to generate nanobubbles in the fluid 202. Each of the sub-tubular structures 402a, 402b can be an implementation of the device 200 or the device 300. In some implementations, at least one of the sub-tubular structure 402a or the sub-tubular structure 402b is an implementation of the device 200. In some implementations, at least one of the sub-tubular structure 402a of the sub-tubular structure 402b is an implementation of the device 300. For example, sub-tubular structure 402a and sub-tubular structure 402b are implementations of the device 200. As another example, sub-tubular structure 402a and sub-tubular structure 402b are implementations of the device 300. As another example, sub-tubular structure 402a is an implementation of the device 200, and sub-tubular structure 402b is an implementation of the device 300. As another example, sub-tubular structure 402a is an implementation of the device 300, and sub-tubular structure 402b is an implementation of the device 200.

Although shown in FIG. 4A as being oriented horizontally (e.g., at a 0° angle with the sub-tubular structures 402a, 402b positioned in line horizontally within the tubular structure 402), the tubular structure 402 can be oriented vertically (e.g., at a 90° angle with the sub-tubular structures 402a, 402b positioned in line vertically within the tubular structure 402) or at a different angle between 0° and 180° (e.g., 30°, 45°, 60°, 120°, 135°, or 150°). In some implementations, as shown in FIG. 4A, the sub-tubular structures 402a, 402b are aligned in a straight line across the tubular structure 402. In implementations where the tubular structure 402 is partitioned into more than two sub-tubular structures, the sub-tubular structures need not be aligned in a straight line across the tubular structure 402. For example, in implementations where the tubular structure 402 includes three sub-tubular structures, the sub-tubular structures can be positioned within the tubular structure 402 such that connecting the centers of the inner bores of the sub-tubular structures forms a triangle. As another example, in implementations where the tubular structure 402 includes four sub-tubular structures, the sub-tubular structures can be positioned within the tubular structure 402 such that connecting the centers of the inner bores of the sub-tubular structures forms a square. As another example, in implementations where the tubular structure 402 includes more than four sub-tubular structures (e.g., five, six, or more than six), the sub-tubular structures can be positioned within the tubular structure 402 in a honeycomb configuration.

FIG. 4B is a side view of an example system 400B for generating nanobubbles in fluid flow. The system 400A includes a manifold 404 that is connected to multiple tubular structures 406a, 406b. Although shown in FIG. 4B as including two tubular structures (406a, 406b), the system 400B can, in other implementations, include additional tubular structures (such as three, four, or more than four). By including more than one tubular structure, the system 400B can, for example, accommodate larger flow of the fluid 202 to generate nanobubbles in the fluid 202. Each of the tubular structures 406a, 406b can be an implementation of the device 200. Each of the tubular structures 406a, 406b can be an implementation of the device 300. In some implementations, at least one of the tubular structure 406a or the sub-tubular structure 406b is an implementation of the device 200. In some implementations, at least one of the tubular structure 406a of the sub-tubular structure 406b is an implementation of the device 300. For example, tubular structure 406a and tubular structure 406b are implementations of the device 200. As another example, tubular structure 406a and tubular structure 406b are implementations of the device 300. As another example, tubular structure 406a is an implementation of the device 200, and tubular structure 406b is an implementation of the device 300. As another example, tubular structure 406a is an implementation of the device 300, and tubular structure 406b is an implementation of the device 200.

The manifold 404 splits flow of the fluid 202 to flow separately through the tubular structures 406a, 406b. In some implementations, the manifold 404 splits flow of the fluid 202 substantially evenly, such that about 50% of the fluid 202 flows through the first tubular structure 406a, while the remaining portion of the fluid 202 flows through the second tubular structure 406a. In some implementations, the manifold 404 splits the flow of the fluid 202 unevenly across the tubular structures 406a, 406b. For example, in cases where a cross-sectional flow area of the tubular structures 406a, 406b are different, the manifold 404 can be sized, shaped, and configured to split the flow of the fluid 202 proportional to the different cross-sectional flow areas of the tubular structures 406a, 406b. As a particular example, in cases where the cross-sectional flow area of the first tubular structure 406a is 50% of the cross-sectional flow area of the second tubular structure 406b, the manifold 404 can be sized, shaped, and configured to split the flow of the fluid 202 such that the portion of the fluid 202 that flows through the second tubular structure 406b is substantially double the portion of the fluid 202 that flows through the first tubular structure 406a (i.e., approximately 33% of the fluid 202 flows through the first tubular structure 406a while approximately 67% of the fluid 202 flows through the second tubular structure 406b).

Although shown in FIG. 4B as being oriented vertically (e.g., at a 90° angle with the tubular structures 406a, 406b positioned vertically), the system 400B can be oriented horizontally (e.g., at a 0° angle with the tubular structures 406a, 406b positioned horizontally at the same height) or at a different angle between 0° and 180°(e.g., 30°, 45°, 60°, 120°, 135°, or 150°). In some implementations, as shown in FIG. 4B, the tubular structures 406a, 406b are aligned in a straight line. In implementations where the system 400B includes more than two tubular structures, the tubular structures need not be aligned in a straight line. For example, in implementations where the system 400B includes three tubular structures, the tubular structures can be positioned such that connecting the centers of the inner bores of the tubular structures forms a triangle. As another example, in implementations where the system 400B includes four tubular structures, the tubular structures can be positioned such that connecting the centers of the inner bores of the tubular structures forms a square. As another example, in implementations where the system 400B includes more than four sub-tubular structures (e.g., five, six, or more than six), the tubular structures can be positioned in a honeycomb configuration. Although shown in FIG. 4B as having the tubular structures 406a, 406b in a parallel configuration, the system 400B can include tubular structures, alternatively or additionally, in a series configuration. For example, the system 400B can include a third tubular structure (an implementation of the device 200 or 300) that is installed in series (downstream or upstream) with respect to the first tubular structure 306a or the second tubular structure 406b.

In some implementations, as shown in FIG. 4B, the manifold 404 is an inlet manifold, and the system 400B includes an outlet manifold 408 connected to the tubular structures 406a, 406b. The outlet manifold 408 can be connected to outlets of the tubular structures 406a, 406b. The outlet manifold 408 is sized, shaped, and configured to receive and rejoin the portions of the fluid 202 that have flowed through the tubular structures 406a, 406b. The fluid 202′ flowing in the outlet manifold 408 is the nanobubble-containing fluid, which can have, for example, a nanobubble concentration of at least 1 million nanobubbles per milliliter. In some implementations, the joined portion of the outlet manifold 408 has a cross-sectional flow area that is substantially equal to the cross-sectional flow area of the joined portion of the manifold 404. In some implementations, the joined portion of the outlet manifold 408 has a cross-sectional flow area that is larger than the cross-sectional flow area of the joined portion of the manifold 404.

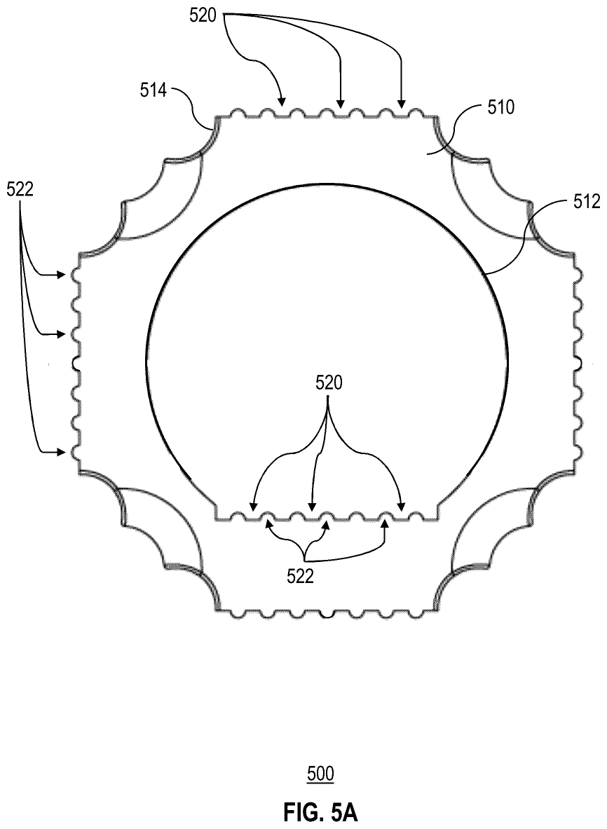

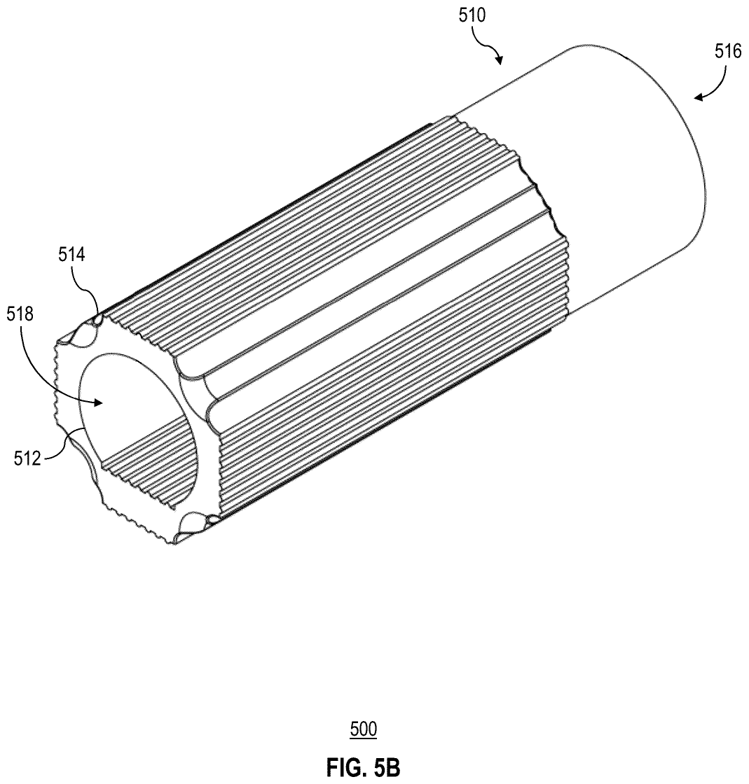

FIGS. 5A and 5B show a side view and a perspective view, respectively, of an example device 500 for generating nanobubbles in fluid flow. The device 500 includes a tubular structure 510 that has an inner surface 512 and an outer surface 514. Open channels 520 are positioned along at least a portion of the inner surface 512 of the tubular structure 510. Open channels 520 are positioned along at least a portion of the outer surface 514 of the tubular structure 510. In some implementations, the device 500 includes open channels 520 positioned along multiple inner surfaces of the tubular structure 510 (for example, similar to the device 300). The tubular structure 510 defines an inlet port 516 and an outlet port 518. The inlet port 516 and the outlet port 518 are on opposing ends of the tubular structure 510 for enabling flow of fluid (such as a fluid 202) through the device 500. The tubular structure 510 is configured to receive the fluid 202 by the inlet port 516 and to discharge the fluid 202 by the outlet port 518. The open channels 520 extend along at least a portion of a length of the tubular structure 510 between the inlet port 516 and the outlet port 518. Fluid flowing through the device 500 flows into the inlet port 516, across the open channels 520, and out of the outlet port 518. Once the fluid flows out of the outlet port 518, the fluid can also flow across the open channels 520 that are positioned along the outer surface 514 of the tubular structure 510. The device 500 is configured to, in response to the fluid 202 flowing across the open channels 520 impose a pressure loss on the fluid 202 of less than about 2 pounds per square inch (psi) differential or less than about 1 psi differential.

Through the presence of the open channels 520, the device 500 is configured to generate nanobubbles in the fluid 202 at a concentration of at least 1 million nanobubbles per milliliter of the fluid 202. For example, while the fluid 202 entering the inlet port 516 might be substantially free of nanobubbles, the fluid 202 exiting the outlet port 518 has a nanobubble concentration of at least 1 million nanobubbles per milliliter of the fluid 202. The nanobubbles generated by the device 500 and included in the fluid 202 exiting the outlet port 518 can have an average diameter of less than one μm or less than 500 nm. In cases where the fluid 202 exiting the outlet port 518 is directed across the open channels 520 that are positioned along the outer surface 514 of the tubular structure 510, the device 500 can generate additional nanobubbles in the fluid 202.

In some implementations, the fluid 202 entering the device 500 includes dissolved gas (e.g., oxygen, nitrogen, air, or a gas including any combinations of these) at a dissolved gas concentration of at least 1 milligram per liter (mg/L). The open channels 520 of the device 500 are configured to convert at least a portion of the dissolved gas into nanobubbles to generate nanobubbles in the fluid 202, independent of introduction of a gas distinct from the dissolved gas already present in the fluid 202.

In the implementation illustrated in FIG. 5, the tubular structure 510 is substantially tubular with a substantially constant cross-sectional area. In some implementations, a cross-sectional area of the tubular structure 510 through which the fluid 202 flows decreases at a location intermediate of the inlet port 516 and the outlet port 518. For example, the tubular structure 510 can have the structure of a Venturi device. The decreased cross-sectional area (constriction) can accelerate the rate of fluid flow through this portion of the tubular structure 510. In some implementations, the open channels 520 are disposed on the inner surface 512 at a portion of the tubular structure 510 with a decreased cross-sectional (constricted) area in comparison to the cross-sectional area of at least one of the inlet port 516 or the outlet port 518.

Each of the open channels 520 is defined as open space between neighboring walls 522. The walls 522 can be, for example, integrally formed with the tubular structure 510 (e.g., as a unitary body) or part of an insert or attachment that is coupled to the tubular structure 510. The walls 522 can be made of a flexible or rigid material. The height of the neighboring walls 522 corresponds to the depth of the respective open channel 520. In some implementations, the depth of each of the open channels 520 is less than about 10 millimeters (mm), less than about 5 mm, less than about 2 mm, or less than about 1 mm. For example, the depth of each of the open channels 520 is about 1 mm or in a range from about 0.5 mm to about 2 mm. In some cases, decreasing the depth of the open channels 520 can improve generation of nanobubbles in the fluid 202. The horizontal distance between neighboring walls 522 corresponds to the width of the respective open channel 520. In some implementations, the width of each of the open channels 520 is less than about 10 mm, less than about 5 mm, less than about 2 mm, or less than about 1 mm. For example, the width of each of the open channels 520 is about 1 mm or in a range from about 0.5 mm to about 2 mm. In some cases, decreasing the width of the open channels 520 can improve generation of nanobubbles in the fluid 202.

In the implementation illustrated in FIG. 5, the walls 522 have a semicircular shape that protrude from the inner and outer surfaces 512, 514. In some implementations, one or more of the walls 522 that bound the respective open channel 520 is slanted, or curved with respect to a reference vertical of the respective open channel 520. For instance, the walls 522 can have geometrical cross-sectional shapes such as hemisphere, ellipse, triangle, trapezoid, rhombus, or any combinations or composites of these. In the illustrated implementation, each of the walls 522 has the same shape. In some implementations, each of the walls 522 has the same shape but is of different size/scale. In some implementations, one or more of the walls 522 have a different shape from the remaining walls 522. In some implementations, one or more of the walls 522 have a different size/dimension from the remaining walls 522. In some cases where neighboring walls 522 are not uniform in size and/or shape, the width of the respective open channel 520 can be defined as the horizontal distance between the tops of the neighboring walls 522. In some cases where neighboring walls 522 are not uniform in size and/or shape, the depth of the respective open channel 520 can be defined as the height of the shorter wall 522.

In the implementation illustrated in FIG. 5, the walls 522 positioned along the inner surface 512 span only a portion (for example, about 25%) of the circumference of the inner surface 512. In some implementations, the walls 522 positioned along the inner surface 512 span more than about 25% of the circumference of the inner surface 512, such as about 30%, about 40%, about 50%, about 60%, about 70%, about 80%, or about 90%. In some implementations, the walls 522 positioned along the inner surface 512 span less than about 25% of the circumference of the inner surface 512, such as about 20% or about 10%. The walls 522 positioned along the inner surface 512 can be located along a region of the circumference of the inner surface 512, for example, where the flow of the fluid 202 is expected to interact most with the inner surface 512 based on flow inertia.

In the implementation illustrated in FIG. 5, the walls 522 positioned along the outer surface 514 span only a portion (for example, about 50%) of the circumference of the outer surface 512. In some implementations, the walls 522 positioned along the outer surface 514 span more than about 50% of the circumference of the outer surface 514, such as about 60%, about 70%, about 80%, or about 90%. In some implementations, the walls 522 positioned along the outer surface 514 span less than about 50% of the circumference of the outer surface 514, such as about 40%, about 30%, about 20%, or about 10%.

In some implementations, the number of walls 522 is greater than the number of open channels 520 by one. For example, a device can include three walls, corresponding to two open channels. In some implementations, the device 500 includes at least two open channels 520 (for example, three, four, five, six, seven, eight, nine, ten, or more than ten). Apart from the walls 522 that bound the open channels 520 positioned along the inner surface 512, the inner bore of the tubular structure 510 can be free of any additional protrusions in order to minimize contact area between the fluid 202 and the inner surface 512 of the device 500, thereby mitigating frictional/pressure losses as the fluid 202 flows through the device 500. Apart from the walls 522 that bound the open channels 520 positioned along the outer surface 514, the outer surface 514 of the tubular structure 510 can be free of any additional protrusions in order to minimize contact area between the fluid 202 and the outer surface 514 of the device 500, thereby mitigating frictional/pressure losses as the fluid 202 flows across the outer surface 514 of the device 500.

The device 500 is connected to a source of liquid that provides the fluid 202 (for example, water). In some implementations, the source of liquid is a vessel or body of water connected to a pump via a suction line. In some implementations, the pump is a variable speed pump. In some implementations, the pump is connected to the device 500 via a discharge line with a control valve. In some implementations, the discharge line is in fluid communication with the tubular structure 510. For example, the liquid carrier flows from the pump, through the control valve, through the discharge line, and to the inlet port 516. The percent opening of the control valve can be adjusted to control the pressure and flow rate of the liquid carrier flowed to the device 500.

In some implementations, the device 500 is connected to a source of gas. In some implementations, the source of gas is connected to the tubular structure 510, the open channels 520, or both. In some implementations, the gas is flowed into the tubular structure 510, the open channels 520, or both, and the gas can diffuse from the device 500 into the fluid 202 as the fluid 202 flows through and across the device 500. As the fluid 202 flows through and across the device 500, the gas that has diffused from the device 500 into the fluid 202 can be converted into nanobubbles. For example, as the gas diffuses from the device 500 and into the fluid 202, the flow of the fluid 202 can shear the gas to generate nanobubbles in the flowing fluid 202. In some implementations, gas is injected into the fluid 202 prior to the fluid 202 flowing into the device 500 (e.g., upstream of the inlet port 516). Introduction of gas can be facilitate generation of nanobubbles in the fluid 202, especially in cases where the fluid 202 has a dissolved gas concentration that is less than one mg/L. In some cases, introduction of additional gas may not be necessary, for example, in cases where the fluid 202 already has a dissolved gas concentration that is equal to or greater than one mg/L. In some cases, introduction of additional gas may be desired, for example, in cases where additional generation of nanobubbles in the fluid 202 is desired to produce a fluid having an even greater concentration of nanobubbles.

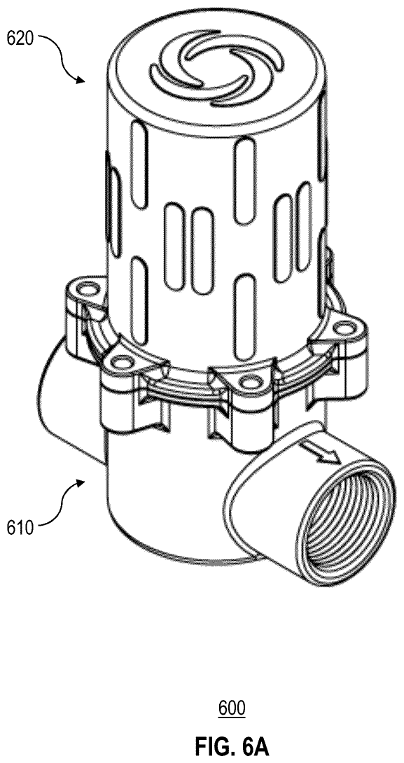

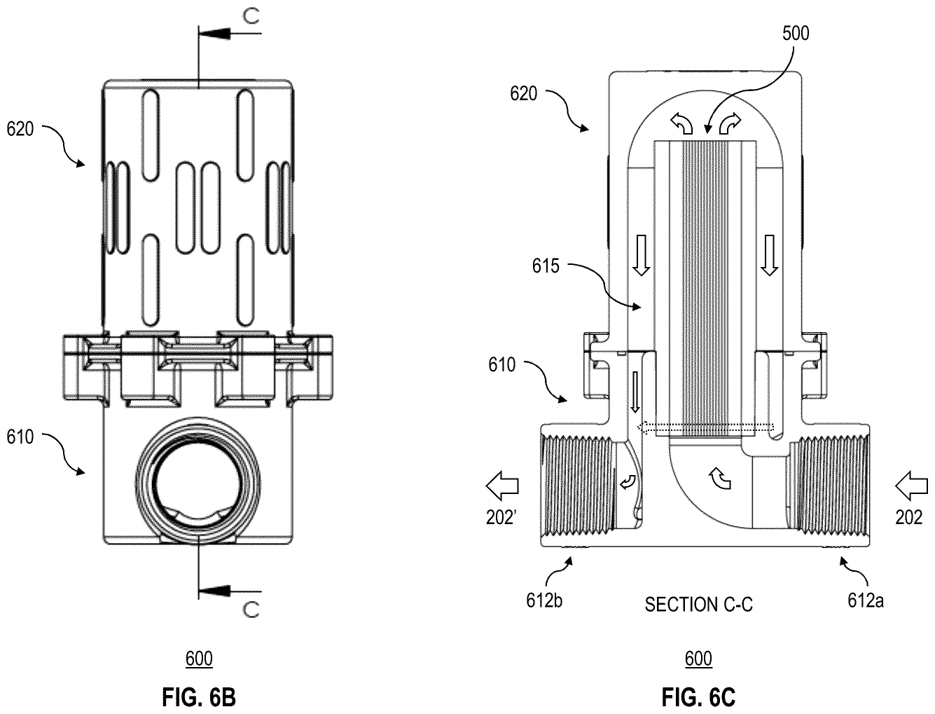

FIGS. 6A, 6B, and 6C show a perspective view, a side view, and a cross-sectional view, respectively, of an example assembly 600 for generating nanobubbles in fluid flow. The assembly 600 includes a connecting member 610, a housing 620, and the device 500. The connecting member 610 is configured to couple to the device 500. For example, the connecting member 610 includes a port sized and shaped to receive the device 500. In some implementations, as shown in FIG. 6C, the device 500 can be at least partially disposed in the port of the connecting member 610. The connecting member 610 is configured to couple to the housing 620. For example, the connecting member 610 includes an open end sized and shaped to connect and seal with the housing 620. The housing 620 defines a void space large enough to surround the portion of the device 500 that is not disposed within the port of the connecting member 610. In some implementations, as shown in FIG. 6C, the housing 620 is not in physical contact with the device 500. When assembled, the assembly 600 defines an annulus 615 between the housing 620 and the device 500. In some implementations, as shown in FIG. 6C, the annulus 615 extends into the connecting member 610.

The connecting member 610 includes an inlet fitting 612a and an outlet fitting 612b. The inlet fitting 612a is sized and shaped to couple to a pipe (not shown). By the inlet fitting 612a, the connecting member 610 is configured to couple to a pipe, for example, for receiving the fluid 202 from the pipe. The outlet fitting 612b is sized and shaped to couple to a pipe (not shown). By the outlet fitting 612b, the connecting member 610 is configured to couple to a pipe, for example, for discharging the fluid 202′ (including nanobubbles) from the assembly 600 to the pipe. In some implementations, as shown in FIG. 6C, the inlet and outlet fittings 612a, 612b are threaded connections that can threadedly couple to pipes. The annulus 615 is in fluid communication with the outlet fitting 612b.

The solid block arrows shown in FIG. 6C represent general directions of fluid flow through the assembly 600. The inner bore of the inlet fitting 612a (receiving the fluid 202) can be in fluid communication with the port (receiving the device 500) by a pipe bend. In some implementations, as shown in FIG. 6C, the pipe bend is a smoothly curved 90° bend. The fluid 202 flows into the inner bore of the inlet fitting 612a, through the pipe bend, and into the inner bore of the device 500. The fluid 202 flows through the inner bore of the device 500. As the fluid 202 flows through the inner bore of the device 500, the fluid 202 flows across the open channels 520 positioned along the inner surface 512. As the fluid 202 flows across the open channels 520 positioned along the inner surface 512, nanobubbles are generated in the fluid 202. In implementations where the walls 522 positioned along the inner surface 512 span only a portion (for example, about 25%) of the circumference of the inner surface 512, the walls 522 can be located at a region of the circumference of the inner surface 512 that is farthest from the inlet fitting 612a (the left region of the device 500 in the example shown in FIG. 6C) to capitalize on the flow inertia of the fluid 202 that has changed direction via the pipe bend. The fluid 202 exits the inner bore of the device 500, and the housing 620 directs flow of the fluid 202 into the annulus 615 between the housing 620 and the outer surface 514 of the device 500. As the fluid 202 flows through the annulus 615, the fluid 202 flows across the open channels 520 positioned along the outer surface 514. As the fluid 202 flows across the open channels 520 positioned along the outer surface 514, nanobubbles are generated in the fluid 202. As mentioned previously, the annulus 615 is in fluid communication with the outlet fitting 612b. The inner bore of the outlet fitting 612b can be in fluid communication with the annulus 615 by a pipe bend. In some implementations, as shown in FIG. 6C, the pipe bend is a sharp 90° bend. The fluid 202′ includes the fluid 202 and the generated nanobubbles. The fluid 202′ flows from the annulus 615 into the inner bore of the outlet fitting 612b. The fluid 202′ flows from the inner bore of the outlet fitting 612b into a pipe that is coupled to the outlet fitting 612b for discharging the fluid 202′ from the assembly 600.

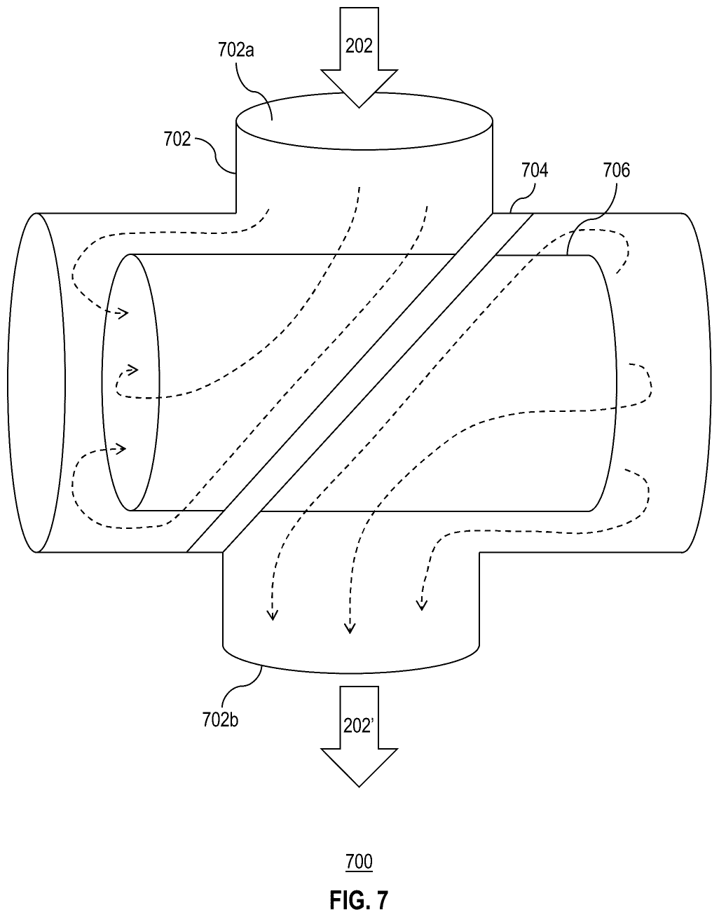

FIG. 7 is a diagram of an example system 700 for generating nanobubbles in fluid flow. The system 700 includes a housing 702, a flow divider 704, and a nanobubble generating device 706. The nanobubble generating device 706 can be, for example, an implementation of the device 200, the device 300, the system 400A, or the device 500. The housing 702 includes an inlet 702a and an outlet 702b. The flow divider 704 is coupled to and disposed within the housing 702. The flow divider 704 divides an inner volume of the housing 702 into a first portion and a second portion. The nanobubble generating device 706 is disposed within the housing 702 and coupled to the flow divider 704. The nanobubble generating device 706 defines an inner bore. The nanobubble generating device 706 includes open channels disposed on an inner surface of the nanobubble generating device 706 (for example, along the inner bore), on an outer surface of the nanobubble generating device 706, or both. A fluid (such as the fluid 202) flows into the inlet 702a, through the inner bore of the nanobubble generating device 706, and out of the outlet 702b as a nanobubble-containing fluid (such as the fluid 202'). As the fluid 202 flows across the open channels of the nanobubble generating device 706, nanobubbles are generated and mix with the fluid 202 to produce the nanobubble-containing fluid 202'. The flow divider 704 is shaped and sized to prevent the fluid 202 from bypassing the inner bore of the nanobubble generating device 706 such that the entirety of the fluid 202 that enters the housing 702 via the inlet 702a flows through the inner bore of the nanobubble generating device 706 before exiting the housing 702 via the outlet 702b. Although shown in FIG. 7 as being generally diagonal, the flow divider 704 can have any shape and size, provided that the flow divider 704 still manages to direct the fluid 202 through the inner bore of the nanobubble generating device 706 such that the fluid 202 does not bypass the inner bore of the nanobubble generating device 706.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,”unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A nanobubble generating device comprising:
a tubular structure having an inner surface and an outer surface, the tubular structure defining an inlet port and an outlet port on opposing ends of the tubular structure for enabling fluid flow through the device; and
open channels disposed on the inner surface of the tubular structure, the open channels extending along at least a portion of a length of the tubular structure between the inlet port and the outlet port.

2. The nanobubble generating device of claim 1, wherein a depth of the open channels is in a range from about 0.5 mm to about 2 mm.

3. The nanobubble generating device of claim 1, wherein a width of each open channel is in a range from about 0.5 mm to about 2 mm.

4. The nanobubble generating device of claim 1, wherein each of the open channels are bounded by walls that are vertical, slanted, or curved with respect to a baseline of the respective open channel.

5. The nanobubble generating device of claim 1, wherein the width of the walls of each of the open channels is in a range from about 0.5 mm to about 5 mm.

6. The nanobubble generating device of claim 4, wherein the walls bounding the open channels have geometrical cross-sectional shapes selected from square, rectangle, hemisphere, ellipse, triangle, trapezoid, rhombus, or any combinations or composites thereof.

7. The nanobubble generating device of claim 1, wherein the open channels are integrally formed with the inner surface of the tubular structure.

8. The nanobubble generating device of claim 1, wherein the open channels are part of an insert or attachment that is coupled to the tubular structure.

9. The nanobubble generating device of claim 1, wherein the tubular structure is partitioned into at least two sub-tubular structures.

10. The nanobubble generating device of claim 1, comprising a second tubular structure, wherein the first tubular structure and the second tubular structure are integrally formed as a composite structure.

11. The nanobubble generating device of claim 1, comprising a second tubular structure, wherein the first tubular structure and the second tubular structure are connected to a common manifold.

12. The nanobubble generating device of claim 10, comprising open channels disposed on an inner surface of the second tubular structure.

13. The nanobubble generating device of claim 1, wherein the tubular structure is configured to receive a fluid by the inlet port and discharge the fluid by the outlet port for flowing the fluid across the open channels, wherein the device is configured to, in response to the fluid flowing into the inlet port, across the open channels, and out of the outlet port, impose a pressure loss on the fluid of less than about 2 pounds per square inch (psi) differential.

14. The nanobubble generating device of claim 13, wherein the fluid comprises dissolved gas at a dissolved gas concentration of at least 1 milligram per liter (mg/L), and the open channels are configured to, in response to the fluid flowing across the open channels, convert at least a portion of the dissolved gas into nanobubbles to generate nanobubbles in the fluid.

15. The nanobubble generating device of claim 14, wherein the open channels are configured to generate nanobubbles in the fluid independent of introduction of a gas distinct from the dissolved gas present in the fluid.

16. The nanobubble generating device of claim 13, wherein the device is configured to generate nanobubbles in the fluid at a concentration of at least 1 million nanobubbles per milliliter of fluid.

17. The nanobubble generating device of claim 1, wherein a cross-sectional area of the tubular structure through which the fluid flows decreases at a location intermediate of the inlet port and the outlet port.

18. The nanobubble generating device of claim 1, wherein the open channels are a first plurality of open channels, wherein the device comprises a second plurality of open channels disposed on the outer surface of the tubular structure, wherein the second plurality of open channels extend along at least a portion of the length of the tubular structure.

19. A method comprising:
flowing a fluid across open channels disposed on an inner surface of a tubular structure, wherein the fluid is a liquid comprising dissolved gas; and
in response to flowing the fluid across the open channels, generating nanobubbles in the fluid.

20. The method of claim 19, wherein generating nanobubbles in the fluid comprises converting at least a portion of the dissolved gas into nanobubbles.

21. The method of claim 19, wherein the fluid that is flowed across the open channels has a Reynolds number in a range from about 8,000 to about 30,000.

22. The method of claim 19, wherein flowing the fluid across the open channels causes a pressure loss on the fluid of less than 2 pounds per square inch (psi) differential.

23. The method of claim 19, wherein the nanobubbles are generated in the fluid such that the fluid has a nanobubble concentration of at least 1 million nanobubbles per milliliter of fluid.

24. The method of claim 19, comprising:
flowing the fluid across open channels disposed on an outer surface of the tubular structure; and
in response to flowing the fluid across the open channels disposed on the outer surface of the tubular structure, generating nanobubbles in the fluid.

25. A nanobubble generating device comprising:
a tubular structure having an inner surface and an outer surface, the tubular structure defining an inlet port and an outlet port on opposing ends of the tubular structure for enabling fluid flow through the device;
a first plurality of open channels disposed on the inner surface of the tubular structure, the first plurality of open channels extending along at least a portion of a length of the tubular structure between the inlet port and the outlet port; and
a second plurality of open channels disposed on the outer surface of the tubular structure, the second plurality of open channels extending along at least a portion of the length of the tubular structure between the inlet port and the outlet port.
